(19) United States
(12) Patent Application Publication
(10) Pub. No.: US 2019/0303611 A1
(43) Pub. Date: Oct. 3, 2019

(54) DETERMINISTIC AND ADAPTIVE DATA MANAGEMENT

(71) Applicant: Microsoft Technology Licensing, LLC, Redmond, WA (US)

(72) Inventors: Todd Randall Lefor, Fargo, ND (US); Michael Francis Falkner, Fargo, ND (US); Shivendushital Pyarelal Pandey, Fargo, ND (US); Matthew Daniel Leonard, Fargo, ND (US); Brian Jon Korbel, Fargo, ND (US)

(21) Appl. No.: 15/993,573

(22) Filed: May 30, 2018

Related U.S. Application Data
(60) Provisional application No. 62/648,924, filed on Mar. 27, 2018.

(51) Int. Cl. G06F 21/62; G06F 17/30

(52) U.S. Cl. CPC G06F 21/6245; G06F 2216/03; G06F 17/30539

(57) ABSTRACT

Data management is provided that enables at least identification and collection of a subset of data subject to special treatment. Attributes can be added to data that identify locations of the subset of data. Locations in one or more computer-accessible data repositories can be scanned by a computer processor for the subset of data based on at least the data attributes and other criteria. Located data can then be collected from the data repositories, presented, and filtered as desired prior to generation of a data package comprising the subset of data. Further, requests to edit or delete identified data can be processed.

### CROSS-REFERENCE TO RELATED APPLICATIONS

This application claims the benefit of U.S. Provisional Application No. 62/648,924 filed Mar. 27, 2018, the entirety of which is incorporated herein by reference.

### BACKGROUND

A subset of data can sometimes be subject to special treatment. For example, a specific class of data may need to be managed or protected in a particular manner. However, the subset of data can be dispersed across numerous data repositories and essentially hidden amongst other data. Accurate and efficient identification and retrieval of the subset of data subject to special treatment can thus be a challenging endeavor.

### SUMMARY

The following presents a simplified summary in order to provide a basic understanding of some aspects of the disclosed subject matter. This summary is not an extensive overview. It is not intended to identify key/critical elements or to delineate the scope of the claimed subject matter. Its sole purpose is to present some concepts in a simplified form as a prelude to the more detailed description that is presented later.

Briefly described, the subject disclosure pertains to data management. Hardcoded or configurable attributes can be added to data to identify locations (e.g., fields) of a class of data. In response to a request for data of a particular class, computer-accessible data repositories can be scanned based on the data attributes and additional criteria. Located data can then be collected from the one or more computer-accessible repositories, presented, and filtered as desired prior to generation of a data package comprising the located data. Further, requests can be processed to edit or delete located data.

To the accomplishment of the foregoing and related ends, certain illustrative aspects of the claimed subject matter are described herein in connection with the following description and the annexed drawings. These aspects are indicative of various ways in which the subject matter may be practiced, all of which are intended to be within the scope of the disclosed subject matter. Other advantages and novel features may become apparent from the following detailed description when considered in conjunction with the drawings.

### BRIEF DESCRIPTION OF THE DRAWINGS

FIG. 1 is a schematic block diagram of a data management system.

FIG. 2 is a schematic block diagram of a representative configuration component.

FIG. 3 is a schematic block diagram of an exemplary data structure.

FIG. 4 is a flow chart diagram of a method of managing data.

FIG. 5 is a flow chart diagram of a method of configuring data management.

FIG. 6 is a flow chart diagram of a method of data recommendation.

FIG. 7 is a flow chart diagram of a method of data alteration.

FIG. 8 is a schematic block diagram illustrating a suitable operating environment for aspects of the subject disclosure.

### DETAILED DESCRIPTION

Systems that manage and process data often require special processing or protections for particular classes of data. Further, a subset of data corresponding to a particular class can essentially be hidden amongst other data across numerous computer-accessible data repositories. Consider for example systems associated with personal data. These systems may have varying types of person descriptions or roles that add to the complexity of the data processed. For instance, a person may be categorized in a system as an actor with a specific role, such as customer, user, vendor, author, worker, applicant, contact, prospect, or engineer, among others. Even more complex systems that manage more than one of these roles easily become overwhelmed with the ability to protect and process data.

The subject disclosure pertains to data management systems and methods that enable accurate and efficient identification, retrieval, and processing of a particular class of data stored in computer-accessible repositories. Attributes can be added to data to identify class membership. For example, a field property of a table can specify metadata that indicates that the data contained therein is that of a particular class of data. Identification and collection of data by a computer from computer-accessible data repositories can subsequently be based on the attributes as well as other criteria. In one embodiment, the attributes are hardcoded or fixed. In another embodiment, the attributes are configurable. In conjunction with configurable attributes, suggestions regarding locations of data of a particular class can be determined and provided to aid in configuration. After data is identified, the data can be subject to editing or deletion. In addition to enabling location of a particular class of data, the data attributes can be utilized to exclude processing of certain kinds, for example for security purposes.

For conciseness and clarity, aspects of the subject disclosure are described with respect to personal data including information related to an identified or identifiable natural person. However, the subject disclosure is not limited thereto but rather contemplates employment with respect to other classes of data. By way of example, and not limitation, another class can be technical data, such that technical data is identified and retrieved from broader data that may include non-technical data.

Various aspects of the subject disclosure are now described in more detail with reference to the annexed drawings, wherein like numerals generally refer to like or corresponding elements throughout. It should be understood, however, that the drawings and detailed description relating thereto are not intended to limit the claimed subject matter to the particular form disclosed. Rather, the intention is to cover all modifications, equivalents, and alternatives falling within the spirit and scope of the claimed subject matter.

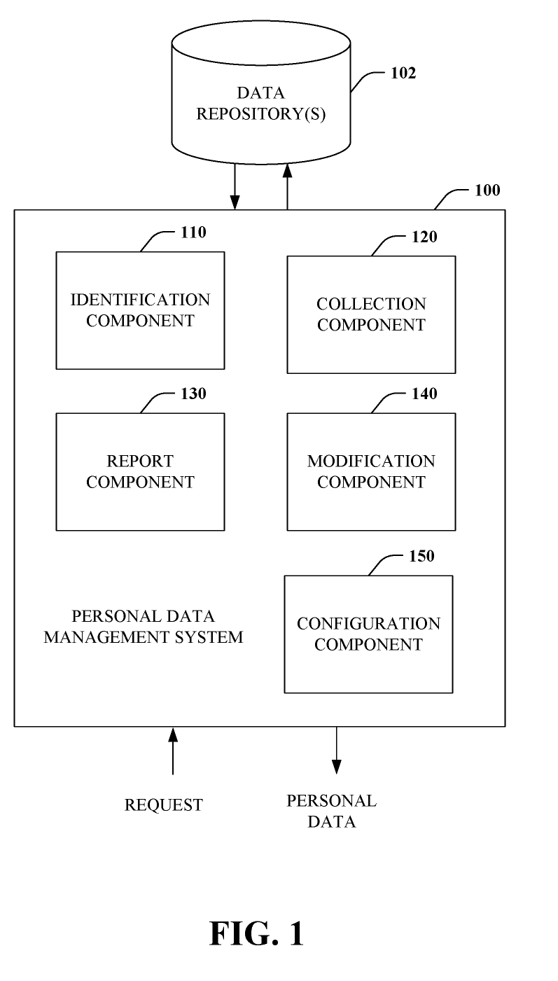

Referring initially to FIG. 1, a data management system 100 is illustrated. The data management system 100 provides a mechanism to identify, acquire, and manage data stored in one or more data repositories. Further, the data management system enables operation with respect to one or more classes of data. One class of data is personal data, which is any information related to an identified or identifiable natural person. Personal data can also belong to distinct categories subject to differing levels of protection, such as sensitive or non-sensitive and public or private, as will be described further hereinafter. For purposes of clarity and simplicity of explanation, however, most disclosed aspects are described in terms of personal data as opposed to the various distinct categories of personal data. Nevertheless, the disclosed aspects are also applicable to these categories of personal data.

As shown, the data management system 100 includes identification component 110, collection component 120, report component 130, modification component 140, and configuration component 150. Further, the data management system 100 can interact with one or more data repositories 102. In one instance, the data repositories 102 can include business data such as transactions and a general ledger.

The identification component 110 is configured to scan the one or more data repositories 102 for personal data. The identification component 110 can receive a request for personal data from a party such as a person or organization and one or more identifiers. For example, a numeric identifier used by a system for the person can be specified. Other identifiers can include but are not limited to name (e.g. first name, last name, nickname . . . ), email address, and postal address. Using the one or more identifiers as criteria, a scan is initiated of the one or more data repositories 102 to identify the personal data for the person. In accordance with one implementation, the scan can also be guided by data attributes.

Data attributes can correspond to metadata (e.g., data about data) that indicate whether a location, such as a data field, comprises personal data or not. For example, a column in a table that comprises a government identification number or credit card number can be attributed to indicate that data that resides in the column is personal data. In one instance, data attributes can mark data locations associated with people and their role (e.g., customer, vendor, worker, contact . . . ).

Data attributes can be hardcoded or configurable. In one instance, data associated with a business application can be hardcoded with data attributes identifying sensitive data. For example, a developer can hardcode attributes for data fields that consistently relate to personal data. In another instance, data can be attributed as personal or not as desired for an application, for instance manually by a developer, automatically or semi-automatically, in a manner that can be changed. It should be appreciated that while some data is consistently personal, other data can depend on context, such as industry. For instance, a purchase of a toy at a toy store may not be personal data, or more specifically sensitive personal data, but a purchase of medication at a pharmacy would be personal data, or more particularly sensitive personal data. Further, a purchase of a bag of chips at a pharmacy would not be sensitive personal data. Accordingly, personal data attribution can be dependent on context including industry and role, among others.

The collection component 120 enables collection or acquisition of identified personal data. More particularly, the identification component 110 can identify specific locations of personal data, and the collection component 120 can retrieve the data from the locations in one or more data repositories. In one instance, export functionality associated with a data repository can be utilized. Alternatively, data can be retrieved from a data repository.

The report component 130 receives the collected personal data from the collection component 120. The report component 130 can initially present the personal data and enable filters to be applied to at least a subset of data to be included or excluded. Subsequently, a data package can be generated with the filtered data. The data package can be a zip file or encoded in XML or other formats. This package can then be transmitted in response to a request, for example by email or other communication medium.

The modification component 140 is configured to enable modification of personal data. Individuals may be given the right to be forgotten. In other words, they can request that their personal data be deleted. The modification component 140 provides a means to request or initiate deletion. In one instance, the modification component 140 can operate in conjunction with the report component 130 and presentation of personal data. In this instance, a request can be made to remove all or a particular subset of personal data. Individuals may also be given the right to correct incorrect personal data. Accordingly, the modification component 140 can also be configured to enable editing or correction of personal data.

The configuration component 150 provides a mechanism to enable configuration of the data management system 100. In one instance, data attribution can be hardcoded. However, this rigid approach may fail to identify all personal data or make a false designation of other data. The configuration component 150 enables a user, such as an administrator, to identify personal as well as non-personal data. Further, default or prior attribution of data as personal or non-personal can be retracted. In accordance with one embodiment, the configuration component 150 can provide a user interface that presents a plurality of data fields that a user can label as personal data or non-personal data, or the like. For example, buttons, check boxes, sliders, or other input mechanisms can be utilized to designate data as personal or not. Based on this input signal, the configuration component 150 can attribute data as specified.

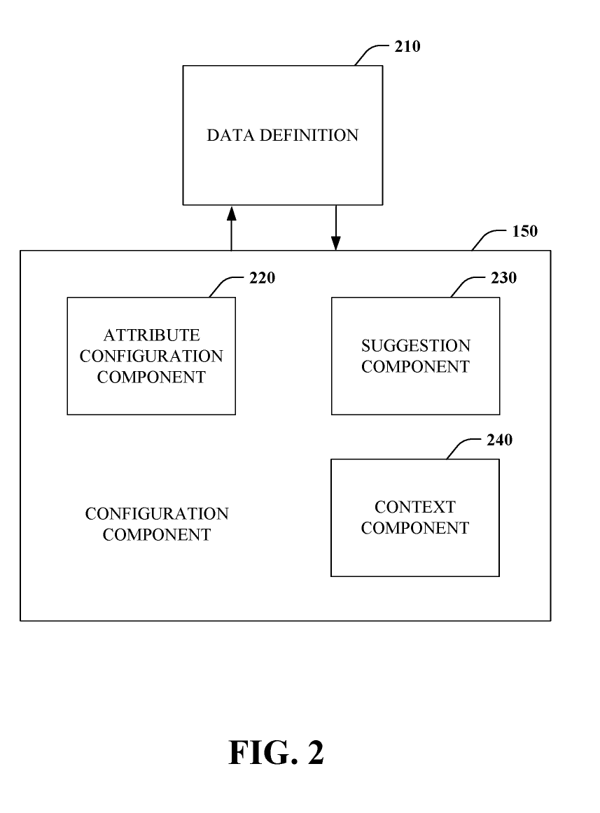

Turning attention to FIG. 2, the configuration component 150 is illustrated in further detail in accordance with one particular embodiment. As shown, the configuration component 150 includes attribute configuration component 220, suggestion component 230, and context component 240, and interacts with data definition 210. The attribute configuration component 220 is configured to label data as personal or non-personal based on an input signal specifying such actions, among other things. Here, the attribute configuration component 220 can operate with respect to the data definition 210, as opposed to the actual data itself. The data definition provides metadata that defines the structure of data. For example, the data definition 210 can define field properties such as width and data type. One additional property can be an attribute that indicates how data in a field is classified such as personal or non-personal. The attribute configuration component 220 can be configured to set this attribute as specified by an administrator, for example.

The suggestion component 230 can aid specification of attributes by determining and providing suggestions regarding what data is personal or non-personal. Further, the suggestion component 230 can determine suggestions based on context data collected and made available by the context component 240. In accordance with one embodiment, the suggestion component 230 can employ machine learning to infer and provide intelligent assistance based on context. For example, there can be an ability to connect with other systems or industries by context component 240, and recommend, by suggestion component 230, attributing data as personal based on what other like systems or industries have done. In another instance, the suggestion component 230 can suggest marking a field as personal data, when ninety percent of a form is marked as including personal data but one other field in a form is not marked as including personal data. Further, data subject to security restrictions or assigned solely to an administrator role, for instance may be suggested as data that should be considered for personal data attribution. In these and other ways, a user may not even know that data is personal but for a suggestion.

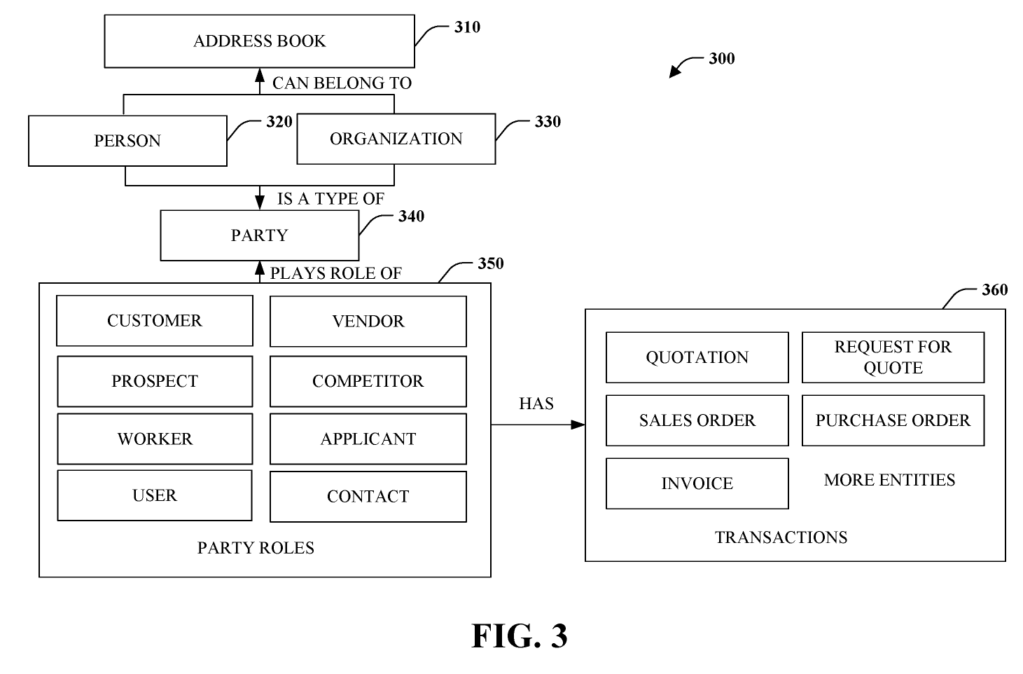

FIG. 3 illustrates an exemplary data structure 300 for business data. The data management system 100 can glean personal information from business data that is not designed for tracking personal information. The data structure 300 shows how people are stored and related in an exemplary business. Address book 310 is the highest-level structure. A person 320 and an organization 330 can belong to the address book. The person 320 and organization 330 are also a type of party 340. In other words, an instance of a person is described as a party. Further, each party can be assigned a unique party identifier (e.g., PartyID). Each party 340 plays a role 350 such as customer, prospect, worker, user, vendor, competitor, applicant, or contact. Furthermore, a person that takes a role such as customer, user, or worker can be assigned a role identifier (e.g., CustID, UserID, WorkerID). Each party role 350 can then have a number of associated transactions 360 including quotation, sales order, invoice, request for quote, and purchase order.

In the data structure 300, personal data associated with a single party 340 can appear with respect to different transactions and data storage entities housing those transactions. Further, a party 340 can have more than one role and thus personal data associated with the party 340 can be present in even more transactions and corresponding storage entities than if the party 340 had a single role. At times retrieval of personal data may be desired. The data management system 100 can provide person search functionality and output a person search report. As input an identifier, name, or address can be entered. The data management system 100 can identify the person based on the input, determine a role played by that person, and locate and retrieve personal data from multiple data storage entities associated with transactions of the person in a particular role. For example, records related to the person can be searched for fields with an attribute indicating the presence of personal data. Further, techniques can extend search based on retrieved data. For instance, if a name “Fred Smith” is provided and an identifier or address are located, the identifier or address can be utilized to further find personal data associated with the same person but with the name, “F. D. Smith.”

The aforementioned systems, architectures, environments, and the like have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component to provide aggregate functionality. Communication between systems, components and/or sub-components can be accomplished in accordance with either a push and/or pull model. The components may also interact with one or more other components not specifically described herein for the sake of brevity, but known by those of skill in the art.

Furthermore, various portions of the disclosed systems above and methods below can include or employ artificial intelligence, machine learning, or knowledge or rule-based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent. By way of example, and not limitation, such mechanisms can be employed with respect to data attribution by automating data attribution and/or providing intelligent suggestions regarding attribution of personal data, for instance based on supervised or non-supervised learning. Further, after some personal data is discovered it can be utilized to further extend the search. For example, if a name is given a party identifier or address can be determined and utilized to locate records with different names for the same person such as if “Fred Smith” is listed as both “Fred Smith” and “F. D. Smith.”

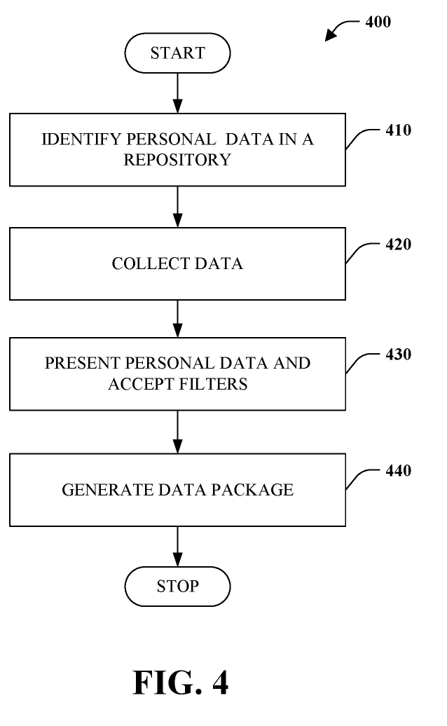

In view of the exemplary systems described above, methodologies that may be implemented in accordance with the disclosed subject matter will be better appreciated with reference to the flow charts of FIG. 4-7. While for purposes of simplicity of explanation, the methodologies are shown and described as a series of blocks, it is to be understood and appreciated that the disclosed subject matter is not limited by the order of the blocks, as some blocks may occur in different orders and/or concurrently with other blocks from what is depicted and described herein. Moreover, not all illustrated blocks may be required to implement the methods described hereinafter. Further, each block or combination of blocks can be implemented by computer program instructions that can be provided to a processor to produce a machine, such that the instructions executing on the processor create a means for implementing functions specified by a flow chart block.

FIG. 4 illustrates a method of managing data 400. At reference numeral 410, personal data is automatically identified by a computer processor in one or more computer-accessible data repositories (e.g., tables stored on a non-volatile computer storage medium). More specifically, one or more identifiers of a person (e.g., name, id, address . . . ) can be received with a request for personal data of the person. In response, personal data of the person can be located based on the identifier as well as data attributes that indicate the location of personal data in a column or field, for example. In other words, given a name, for instance, a scan of a data repository can be performed to identify rows of tables that include the name, and any fields that include an attribute that indicate the presence of personal data can be identified. Further, the identification can exploit known relationships between entities, or tables, to scan for personal data across tables. At reference numeral 420, the identified personal data is collected. Collection can be accomplished by exporting data from tables matching one or more identifiers of a person and particular fields thereof. Alternatively, collection can be achieved by directly retrieving the data or a copy thereof from a repository. Subsequently, at 430, the collected personal data can be presented and subject to filtering such as omitting particular data as not personal, for example. For example, collected data can be presented on a display screen to an administrator who can select to include or exclude data as personal by way of a filter based on his/her knowledge of the data. At numeral 440, a data package is generated including the personal data, optionally filtered. This package can be can encoded as a zip file, XML or CVS and communicated to a requesting party.

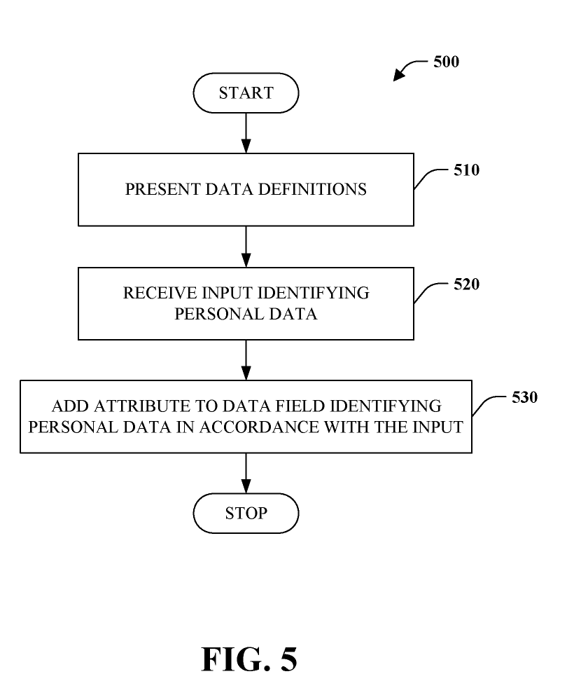

FIG. 5 illustrates a method 500 of configuring the data management system 100. At reference numeral 510, data definitions are acquired and presented, for instance on a display screen. For example, database fields can be presented. At reference numeral 520, input can be received identifying personal data. By way of example, data fields can be presented with a button, checkbox, or other input mechanism that a user can employ to indicate that the field includes personal data. At numeral 530, an attribute can be added to the data definition, such as field properties, identifying data has personal in accordance with the received input. Further, received input may deselect a data field that was previously specified as including personal data manually or by default. In this case, the corresponding attribute can be removed or set to indicate the data is not personal.

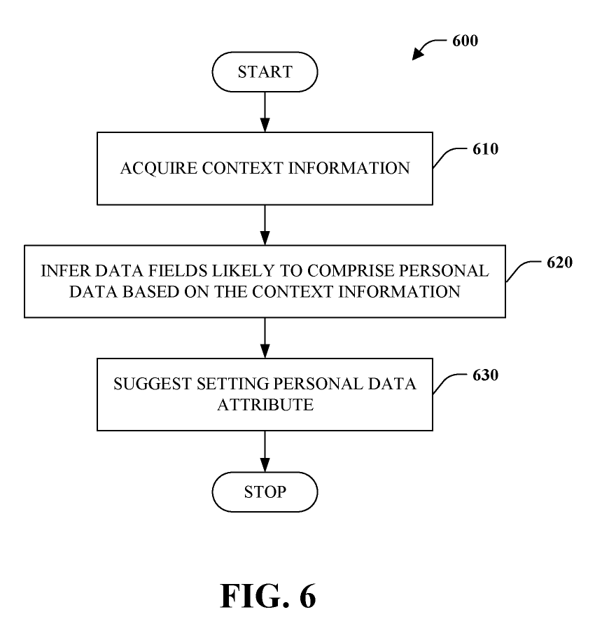

FIG. 6 is a method of data recommendation 600. At reference numeral 610, context information can be acquired from one or more sources. For example, context information can include historical information relating to designation of data as personal or non-personal. For instance, context information can be gathered regarding a number of enterprises in a particular industry that have tagged data as personal. At numeral 620, a data field, or other location, is inferred to likely comprise personal data based on the context information. The inference can be made using machine learning techniques such as, but not limited to. neural networks, expert systems, or Bayesian belief networks. As a simple example for clarifying understanding, data fields relating to a particular industry can be inferred to include personal data based on attribution of such data fields as personal by another enterprise in the same industry. In another example, if all but one data field in a grouping of data are attributed as including personal data, the remaining data field can be inferred to potentially include personal data. At reference numeral 630, suggestions, or recommendations, are provided to set a personal data attribute.

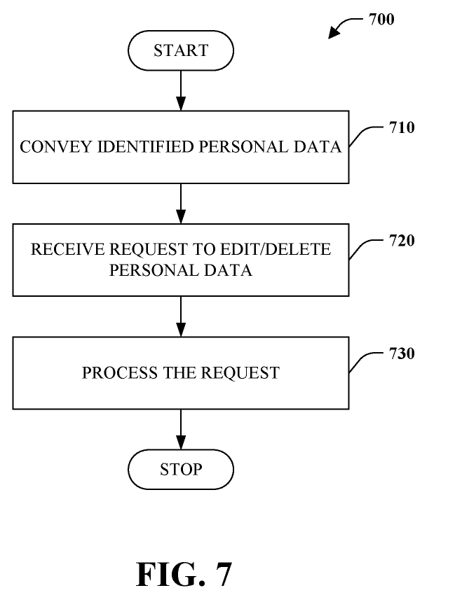

FIG. 7 is a flow chart diagram of a method 700 of altering personal data. A governmental regulation or industry certification may require not only identification of personal information stored about a use but the ability to alter or delete personal data. At reference numeral 710, collected identified personal data is conveyed, for example for viewing on a display device. At numeral 720, a request is received to edit or delete at least a portion of the personal data. For example, personal data can be inaccurate or include spelling problems that are to be remedied. Alternatively, a request can be made to delete all or a portion of personal data related to a person. At reference numeral 730, processing of the request on the data can be initiated.

For clarity and simplicity, aspects of the subject disclosure have been described with respect to personal data and a dichotomy of personal data versus non-personal data. However, personal data can be of a variety of types including sensitive or non-sensitive and public or private. Identification and collection of personal data can be performed with respect to distinct types of personal data.

Personal data means any information related to an identified or identifiable natural person. An identified person is one who can be identified, directly, or indirectly in particular by reference to an identifier such as a name, an identification number, location data, online identifier or one or more factors specific to the physical, physiological, genetic, mental, economic, cultural, or social identify of that person.

Sensitive personal data are special categories of personal data that are subject to additional protections including personal data revealing racial or ethnic origin, political opinions, religious or philosophical beliefs, trade union membership, data concerning health or sex life and sexual orientation, genetic data or biometric data, criminal offenses, and convictions. Data not subject to additional protections can be deemed non-sensitive.

Private versus public personal data is another distinction. Private personal data is data about a natural person that is not available to the general public. For instance, ethnicity, medical data, and financial data can be private personal data. Public personal data can be information that can be freely used and distributed by anyone with no restrictions on access or usage. For example, a person's name can be personal data, but can be deemed public personal data. As another distinguishing example, an online purchase of a shirt, pants, and shoes is typically private personal data. However, if the person who made the purchase posts purchase on social media it becomes public personal data.

Aspects of the subject disclosure pertain to the technical problem of managing and protecting data. The technical features associated with addressing this problem comprise classifying data with a data attribute. For example, a data field definition can include an attribute that indicates data is personal or non-personal. Utilizing this attribute data can be accurately and quickly identified and acquired even with limited identification information regarding a person, for instance. Further, the attribute can be utilized to control other processing to secure data from access or misuse, among other things. Data attribution can also be hardcoded or configurable to further ensure accuracy. Once acquired data can be corrected or deleted if desired, among other things.

The subject disclosure supports various products and processes that perform, or are configured to perform, various actions regarding managing data. What follows are one or more exemplary systems and methods.

A data management system comprises: a processor coupled to a memory, the processor configured to execute computer-executable instructions stored in the memory that when executed cause the processor to perform the following actions: receiving a request for personal data and at least one identifier of a person; scanning locations of one or more data repositories of business data for the personal data of the person based on the at least one identifier and data attributes identifying locations of personal data; and collecting the personal data from the one or more data repositories from locations identified by the scanning. In one instance, the data attributes specify data fields that include personal data. In another instance, the data attributes are configurable. The system further comprises receiving selection of a subset of personal data to include or exclude and filtering the personal data based on the selection. The system further comprises generating a package comprising filtered personal data in a designated encoding format. In the system, the personal data can be sensitive personal data or private personal data.

A method of personal data management comprising: employing at least one processor configured to execute computer-executable instructions stored in a memory that when executed cause the at least one processor to perform the following acts: scanning one or more data repositories of business data for personal data of a person a person in response to a request for the personal data based on at least one identifier of the person and data attributes identifying locations of personal data; and collecting identified personal data of the person from the one or more data repositories. The method further comprising scanning of the one or more data repositories based on a data attribute that indicates presence of personal data in a data field. Th method further comprising filtering collected personal data based on an input identifying data to include or exclude, and generating a package comprising filtered personal data in a designated encoding format. The method further comprising setting at least a subset of the data attributes to indicate personal data or non-personal data. Further, the method comprises suggesting attributing data as personal based on industry and historical data. The method further comprising editing or deleting at least a subset of the identified personal data in response to a request.

A system of data management comprising: means for identifying a subset of data corresponding to a class of data in one or more computer-accessible data repositories in response to a request for the subset of data based on data attributes that identify locations of the class of data; and means for collecting the subset of data from the one or more computer-accessible data repositories. The system further comprising means for identifying the subset of data based on a data field attribute. The system further comprising a means for configuring at least a subset of the data attributes with an indication of a class of data. Further, the means for identifying the subset is based on a data attribute that indicates the presence of technical data.

As used herein, the terms “component” and “system,” as well as various forms thereof (e.g., components, systems, sub-systems . . . ) are intended to refer to a computer-related entity, either hardware, a combination of hardware and software, software, or software in execution. For example, a component may be, but is not limited to being, a process running on a processor, a processor, an object, an instance, an executable, a thread of execution, a program, and/or a computer. By way of illustration, both an application running on a computer and the computer can be a component. One or more components may reside within a process and/or thread of execution and a component may be localized on one computer and/or distributed between two or more computers.

The conjunction “or” as used in this description and appended claims is intended to mean an inclusive “or” rather than an exclusive “or,” unless otherwise specified or clear from context. In other words, “‘X’ or ‘Y’” is intended to mean any inclusive permutations of “X” and “Y.” For example, if “‘A’ employs ‘X,’” “‘A employs ‘Y,’” or “‘A’ employs both ‘X’ and ‘Y,’” then “‘A’ employs ‘X’ or ‘Y’” is satisfied under any of the foregoing instances.

Furthermore, to the extent that the terms “includes,” “contains,” “has,” “having” or variations in form thereof are used in either the detailed description or the claims, such terms are intended to be inclusive in a manner similar to the term “comprising” as “comprising” is interpreted when employed as a transitional word in a claim.

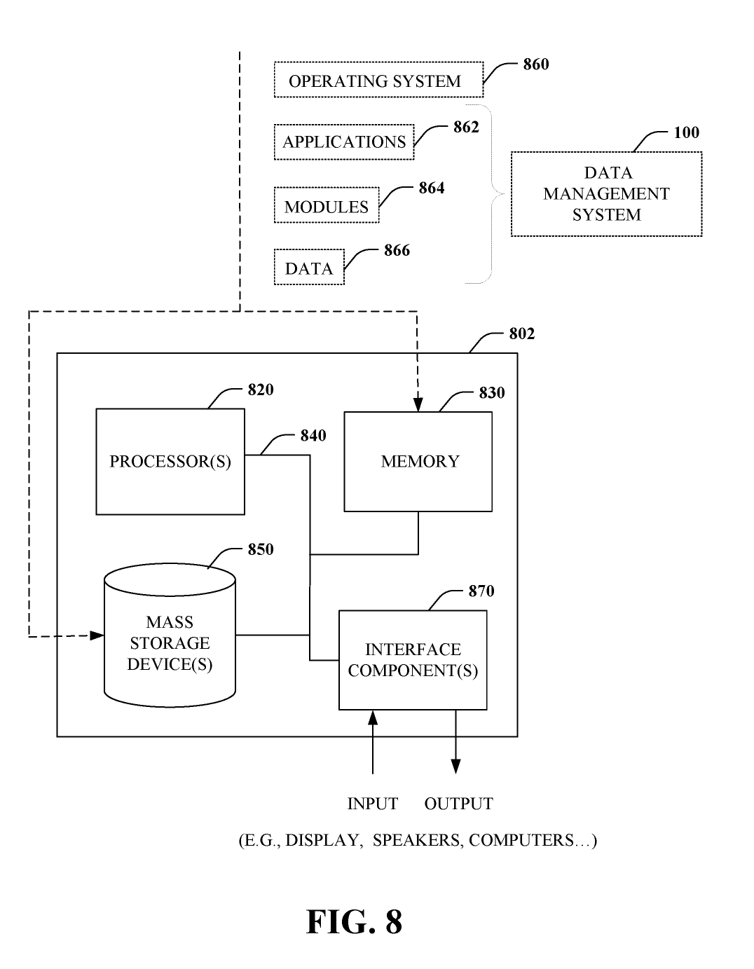

In order to provide a context for the disclosed subject matter, FIG. 8 as well as the following discussion are intended to provide a brief, general description of a suitable environment in which various aspects of the disclosed subject matter can be implemented. The suitable environment, however, is only an example and is not intended to suggest any limitation as to scope of use or functionality.

While the above disclosed system and methods can be described in the general context of computer-executable instructions of a program that runs on one or more computers, those skilled in the art will recognize that aspects can also be implemented in combination with other program modules or the like. Generally, program modules include routines, programs, components, data structures, among other things that perform particular tasks and/or implement particular abstract data types. Moreover, those skilled in the art will appreciate that the above systems and methods can be practiced with various computer system configurations, including single-processor, multi-processor or multi-core processor computer systems, mini-computing devices, mainframe computers, as well as personal computers, hand-held computing devices (e.g., personal digital assistant (PDA), smart phone, tablet, watch . . . ), microprocessor-based or programmable consumer or industrial electronics, and the like. Aspects can also be practiced in distributed computing environments where tasks are performed by remote processing devices that are linked through a communications network. However, some, if not all aspects, of the disclosed subject matter can be practiced on stand-alone computers. In a distributed computing environment, program modules may be located in one or both of local and remote memory devices.

With reference to FIG. 8, illustrated is an example general-purpose computer or computing device 802 (e.g., desktop, laptop, tablet, watch, server, hand-held, programmable consumer or industrial electronics, set-top box, game system, compute node . . . ). The computer 802 includes one or more processor(s) 820, memory 830, system bus 840, mass storage device(s) 850, and one or more interface components 870. The system bus 840 communicatively couples at least the above system constituents. However, it is to be appreciated that in its simplest form the computer 802 can include one or more processors 820 coupled to memory 830 that execute various computer executable actions, instructions, and or components stored in memory 830.

The processor(s) 820 can be implemented with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. The processor(s) 820 may also be implemented as a combination of computing devices, for example a combination of a DSP and a microprocessor, a plurality of microprocessors, multi-core processors, one or more microprocessors in conjunction with a DSP core, or any other such configuration. In one embodiment, the processor(s) 820 can be a graphics processor.

The computer 802 can include or otherwise interact with a variety of computer-readable media to facilitate control of the computer 802 to implement one or more aspects of the disclosed subject matter. The computer-readable media can be any available media that can be accessed by the computer 802 and includes volatile and nonvolatile media, and removable and non-removable media. Computer-readable media can comprise two distinct and mutually exclusive types, namely computer storage media and communication media.

Computer storage media includes volatile and nonvolatile, removable and non-removable media implemented in any method or technology for storage of information such as computer-readable instructions, data structures, program modules, or other data. Computer storage media includes storage devices such as memory devices (e.g., random access memory (RAM), read-only memory (ROM), electrically erasable programmable read-only memory (EEPROM) . . . ), magnetic storage devices (e.g., hard disk, floppy disk, cassettes, tape . . . ), optical disks (e.g., compact disk (CD), digital versatile disk (DVD) . . . ), and solid state devices (e.g., solid state drive (SSD), flash memory drive (e.g., card, stick, key drive . . . ) . . . ), or any other like mediums that store, as opposed to transmit or communicate, the desired information accessible by the computer 802. Accordingly, computer storage media excludes modulated data signals as well as that described with respect to communication media.

Communication media embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

Memory 830 and mass storage device(s) 850 are examples of computer-readable storage media. Depending on the exact configuration and type of computing device, memory 830 may be volatile (e.g., RAM), non-volatile (e.g., ROM, flash memory . . . ) or some combination of the two. By way of example, the basic input/output system (BIOS), including basic routines to transfer information between elements within the computer 802, such as during start-up, can be stored in nonvolatile memory, while volatile memory can act as external cache memory to facilitate processing by the processor(s) 820, among other things.

Mass storage device(s) 850 includes removable/non-removable, volatile/non-volatile computer storage media for storage of large amounts of data relative to the memory 830. For example, mass storage device(s) 850 includes, but is not limited to, one or more devices such as a magnetic or optical disk drive, floppy disk drive, flash memory, solid-state drive, or memory stick.

Memory 830 and mass storage device(s) 850 can include, or have stored therein, operating system 860, one or more applications 862, one or more program modules 864, and data 866. The operating system 860 acts to control and allocate resources of the computer 802. Applications 862 include one or both of system and application software and can exploit management of resources by the operating system 860 through program modules 864 and data 866 stored in memory 830 and/or mass storage device(s) 850 to perform one or more actions. Accordingly, applications 862 can turn a general-purpose computer 802 into a specialized machine in accordance with the logic provided thereby.

All or portions of the claimed subject matter can be implemented using standard programming and/or engineering techniques to produce software, firmware, hardware, or any combination thereof to control a computer to realize the disclosed functionality. By way of example and not limitation, the data management system 100, or portions thereof, can be, or form part, of an application 862, and include one or more modules 864 and data 866 stored in memory and/or mass storage device(s) 850 whose functionality can be realized when executed by one or more processor(s) 820.

In accordance with one particular embodiment, the processor(s) 820 can correspond to a system on a chip (SOC) or like architecture including, or in other words integrating, both hardware and software on a single integrated circuit substrate. Here, the processor(s) 820 can include one or more processors as well as memory at least similar to processor(s) 820 and memory 830, among other things. Conventional processors include a minimal amount of hardware and software and rely extensively on external hardware and software. By contrast, an SOC implementation of processor is more powerful, as it embeds hardware and software therein that enable particular functionality with minimal or no reliance on external hardware and software. For example, the data management system 100 and/or associated functionality can be embedded within hardware in a SOC architecture.

The computer 802 also includes one or more interface components 870 that are communicatively coupled to the system bus 840 and facilitate interaction with the computer 802. By way of example, the interface component 870 can be a port (e.g. serial, parallel, PCMCIA, USB, FireWire . . . ) or an interface card (e.g., sound, video . . . ) or the like. In one example implementation, the interface component 870 can be embodied as a user input/output interface to enable a user to enter commands and information into the computer 802, for instance by way of one or more gestures or voice input, through one or more input devices (e.g., pointing device such as a mouse, trackball, stylus, touch pad, keyboard, microphone, joystick, game pad, satellite dish, scanner, camera, other computer . . . ). In another example implementation, the interface component 870 can be embodied as an output peripheral interface to supply output to displays (e.g., LCD, LED, plasma, organic light-emitting diode display (OLED) . . . ), speakers, printers, and/or other computers, among other things. Still further yet, the interface component 870 can be embodied as a network interface to enable communication with other computing devices (not shown), such as over a wired or wireless communications link.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications, and variations that fall within the spirit and scope of the appended claims.

What is claimed is:

1. A data management system, comprising:
a processor coupled to a memory, the processor configured to execute computer-executable instructions stored in the memory that when executed cause the processor to perform the following actions:
receiving a request for personal data and at least one identifier of a person;
scanning locations of one or more data repositories of business data for the personal data of the person based on the at least one identifier and data attributes identifying locations of personal data; and
collecting the personal data from the one or more data repositories from locations identified by the scanning.

2. The system of claim 1, the data attributes specify data fields that include personal data.

3. The system of claim 1, the data attributes are configurable.

4. The system of claim 3, suggesting attributing data as personal based on at least one of historical data and industry.

5. The system of claim 1 further comprises:
conveying, for display on a display device, the personal data;
receiving selection of a subset of personal data to include or exclude; and
filtering the personal data based on the selection.

6. The system of claim 5 further comprising generating a package comprising filtered personal data in a designated encoding format.

7. The system of claim 1, the personal data is sensitive personal data.

8. The system of claim 7, the personal data is private personal data.

9. A method of data management, comprising:
employing at least one processor configured to execute computer-executable instructions stored in a memory that when executed cause the at least one processor to perform the following acts:
scanning one or more data repositories of business data for personal data of a person a person in response to a request for the personal data based on at least one identifier of the person and data attributes identifying locations of personal data; and
collecting identified personal data of the person from the one or more data repositories.

10. The method of claim 9 further comprising scanning of the one or more data repositories based on a data attribute that indicates presence of personal data in a data field.

11. The method of claim 9 further comprising filtering collected personal data based on an input identifying data to include or exclude.

12. The method of claim 11 further comprising generating a package comprising filtered personal data in a designated encoding format.

13. The method of claim 9 further comprising setting at least a subset of the data attributes to indicate personal data or non-personal data.

14. The method of claim 13 further comprising suggesting attributing data as personal based on industry.

15. The method of claim 14 further comprising suggesting attributing data as personal based on historical data.

16. The method of claim 9 further comprising editing or deleting at least a subset of the identified personal data in response to a request.

17. A system of data management, comprising:
means for identifying a subset of data corresponding to a class of data in one or more computer-accessible data repositories in response to a request for the subset of data based on data attributes that identify locations of the class of data; and
means for collecting the subset of data from the one or more computer-accessible data repositories.

18. The system of claim 17 further comprising a means for identifying the subset of data based on a data field attribute.

19. The system of claim 17 further comprising a means for configuring at least a subset of the data attributes with an indication of a class of data.

20. The system of claim 17, the means for identifying the subset is based on a data attribute that indicates presence of technical data.
